(19) United States
(12) Patent Application Publication
(10) Pub. No.: US 2026/0222243 A1
(43) Pub. Date: Jul. 30, 2026

(54) TRANSMISSION OF SIGNALS IN A CONTROL SYSTEM

(71) Applicant: BSH HAUSGERÄTE GMBH, München (DE)

(72) Inventors: Martin WINKLER, Nittenau (DE); Kai Achim KROPP, Wald (DE)

(21) Appl. No.: 19/147,424

(22) PCT Filed: Mar. 7, 2024
(86) PCT No.: PCT/EP2024/055999

§ 371 Date: Jul. 11, 2025

(30) Foreign Application Priority Data
Mar. 9, 2023 (DE) 10 2023 202 137.4

(51) Int. Cl. H04L 12/40; G08C 19/02

(52) U.S. Cl. CPC H04L 12/40013; G08C 19/02

(57) ABSTRACT

A control system includes a first control apparatus, a plurality of second control apparatuses, and a signal line that connects the first and second control apparatuses to one another. The first control apparatus is configured so as to determine a total current that is flowing through the signal line. A second control apparatus is configured, in order to transmit a signal, so as to cause a current flowing out of the signal line. The current is a predetermined multiple of a predetermined base current. Different multiples are allocated to different signals. First and second control apparatuses, a household appliance and a method for transmitting signals via the signal line, are also provided.

The invention relates to a control system having a first and a plurality of second control apparatuses. In particular, the invention relates to the transmission of signals in such a control system.

A household appliance comprises a control system having a plurality of control apparatuses. A first control apparatus can assume central control tasks, while a plurality of second control apparatuses can be switched off for dedicated purposes. It is possible for one of the second control apparatuses to determine a state or event that is to be signaled to the first control apparatus. For example, one of the second control apparatuses can determine a fault that it cannot remedy itself or that also has an effect on another control apparatus.

For rapid signaling between the control apparatuses, an interrupt request can be transmitted. If a data connection between the control apparatuses is used for this purpose, a data traffic that is currently taking place can delay the transmission of the interrupt request. Therefore, a dedicated signal line is often used to signal the interrupt request.

In one embodiment, a dedicated signal line is allocated to each second control apparatus. In another embodiment, a common signal line is provided on which a predetermined level is controlled in order to send an interrupt request.

It is possible for each of the second control apparatuses to cause this level, so that the first control apparatus can determine an interrupt request from each second control apparatus. However, it can be difficult or time-consuming to determine the actual originator of the interrupt request among the second control apparatuses. In addition, this approach does not support different priorities, and it is not possible to distinguish between an urgent and a less urgent interrupt request.

In yet another embodiment, the signal line runs successively through the second control apparatuses from the first control apparatus (daisy chain). In order to generate an interrupt request, a second control apparatus can disconnect the signal line and apply it to a predetermined level. An order in which the second control apparatuses are connected to one another thereby determines a priority. However, the priority is hardwired and cannot be changed by configuration.

One object of the present invention is to provide an improved technique for transmitting a signal from a plurality of control apparatuses to a further control apparatus. The invention achieves this object by means of the subjects of the independent claims. Subordinate claims reflect preferred embodiments.

According to a first aspect of the present invention, a control system comprises a first control apparatus, a plurality of second control apparatuses, and a signal line that connects the first and second control apparatuses to one another. The first control apparatus is configured so as to determine a total current that is flowing through the signal line. A second control apparatus is configured so as, in order to transmit a signal, to cause a current flowing out of the signal line, wherein the current is a predetermined multiple of a predetermined base current. Different multiples are allocated to different signals.

In the control system, a plurality of signals can be transmitted simultaneously via only a single signal line. Each signal is represented by a current, wherein a plurality of individual currents add up to form a total current. The first control apparatus can determine the total current and infer the individual currents therefrom. In this way, it can be determined directly which combination of a plurality of signals is transmitted via the signal line at a predetermined time.

In this manner, a signaled state or event can be quickly handled by the first control apparatus. Due to the requirement of only a single signal line, the control system can be constructed in a simple and space-saving manner. The transmission does not use any priorities, and all predetermined signals can be transmitted simultaneously. An order in which the first control apparatus evaluates signals or responds thereto can be determined independently of the system architecture. In this manner, reconfigurable priorities can also be supported.

The base current can be determined in dependence upon parameters of the control system. For example, possible interference influences on the signal line, for example of an electromagnetic nature, or a constancy of a power supply of the control system, can be taken into account.

In a first variant of the control system, the second control apparatuses are each allocated different multiples. A signal indicates one of the second control apparatuses. Thus, the second control apparatuses can provide signals in parallel with one another, which in each case indicate that a respective second control apparatus requires the attention of the first control apparatus.

In a second variant, predetermined events or states are allocated different multiples. A signal can indicate one of the events. In this way, system-wide defined events can be determined and signaled at various second control apparatuses. For example, in a distributed or concurrent system or a system in which a task is performed by distributed second control apparatuses, this allocation can be advantageous. In this variant, it is preferable for the second control apparatuses to be allocated disjoint sets of signals in order to avoid simultaneous provision of the same signal from different second control apparatuses.

It is particularly preferred that different multiples are different integer powers of the number two. In this manner, the multiples can be one, two, four, eight, 16, 32, etc. Individual currents can thus be determined in an improved manner on the basis of the total current. It is generally preferable for all currents to have the same sign. The exponent of the integer power is preferably also positive, but it is also possible to work with negative exponents. Even more preferably, a series of consecutive integers is used as powers.

The first control apparatus can comprise an analog-to-digital converter that is configured so as to provide a binary representation of the determined total current with the result that a bit of the binary representation corresponds to a predetermined signal. Such analog-to-digital converters (ADCs) can be available at low cost and are already integrated in some microprocessors or microcontrollers. The breakdown of the total current into a superposition of signals can thus be performed quickly and easily.

The analog-to-digital converter can have a resolution in bits that is greater than a number of different multiples; wherein at least one least significant bit is not evaluated. A measurement uncertainty of the analog-to-digital converter can be expressed in the fact that one or more least significant bits do not represent reliable information. By dispensing with one or more least significant bits (LSB), such effects can be filtered out. For example, a 12-bit ADC can be used to decode a total current that is provided by ten different second control apparatuses. Each control apparatus is allocated one bit of the ADC, wherein the least significant two bits are not evaluated.

In one embodiment, the total current comprises a predetermined offset, which corresponds to half of the base current. The offset can be caused permanently by the signal line. As a result, a positive and a negative deviation of the measured value from the sum of the currents that are provided by the second control apparatuses can be filtered out in an improved manner. Such a deviation can be caused, for example, by interference or noise.

In a particularly preferred embodiment, the first control apparatus comprises a voltage source that is connected to the signal line. The voltage that is provided by the voltage source can be fixedly predetermined or can be determined by the first control apparatus, for example by means of a further ADC. In one embodiment, a voltage that is provided by the voltage source can be controlled by the first control apparatus. At the first control apparatus, the total current preferably flows through a resistor having a predetermined conductance. A voltage that drops across the resistor is then proportional to the total current and can be determined with respect to the voltage that is provided.

Preferably, one of the second control apparatuses is configured so as to cause a predetermined minimum current through the signal line. The first control apparatus is configured so as to determine a fault in the signal line if the total current is below the minimum current. If the minimum current is not complied with, there can be a break in the control line, for example, which could interrupt the transmission of a signal. Signal currents are preferably generated in addition to the minimum current, and the first control apparatus determines the total current with respect to the minimum current. The minimum current can comprise the offset or can be impressed on the signal line in addition to it.

It is further preferred that the second control apparatus, which is furthest away from the first control apparatus with respect to the control line, causes the minimum current. By maximizing the distance, it is possible to notice any interference that lies on the signal line. An unnoticed interference cannot occur in this way.

The control system comprises a first and a plurality of second control apparatuses, which are each configured to implement a technique described herein. A first control apparatus comprises a terminal for a signal line; a current sensor for determining a current flowing through the signal line; and a processing facility that is configured so as to deconstruct the determined current into predetermined summands that each represent a signal; wherein a summand is a predetermined multiple of a predetermined base current, and wherein different multiples are allocated to different signals.

A second control apparatus comprises a terminal for a signal line; a current sink for causing an electric current through the terminal, wherein the current is a predetermined multiple of a predetermined base current; and a processing facility for controlling the current sink in dependence upon a signal that is to be provided on the signal line. Different multiples are allocated to different signals.

According to a further aspect of the present invention, a household appliance comprises a control system described herein, a first control apparatus described herein, or a second control apparatus described herein. The household appliance can comprise, for example, a kitchen appliance, a laundry care appliance or a cooling appliance. Other appliances that are used in particular in the context of a household are also possible.

According to yet another aspect of the present invention, a method for transmitting signals via a signal line that connects a first and a plurality of second control apparatuses to one another comprises steps of causing currents from the signal line by one of the second control apparatuses; wherein each current is a predetermined multiple of a base current, and different multiples are allocated to different signals to be transmitted; determining a total current flowing through the signal line by the first control apparatus; and determining signals that are provided by the second control apparatuses.

The method can be implemented by means of a control system described herein. The control system can comprise one or more processing facilities that can be involved in the implementation of the method. For this purpose, a processing facility can be embodied electronically and comprise, for example, a programmable microcomputer or microcontroller. The method can be in the form of a computer program product having program code means. The computer program product can also be stored on a computer-readable data carrier. Features or advantages of the method can be transferred to the apparatus or vice versa.

The invention will now be described in more detail with reference to the accompanying figures in which:

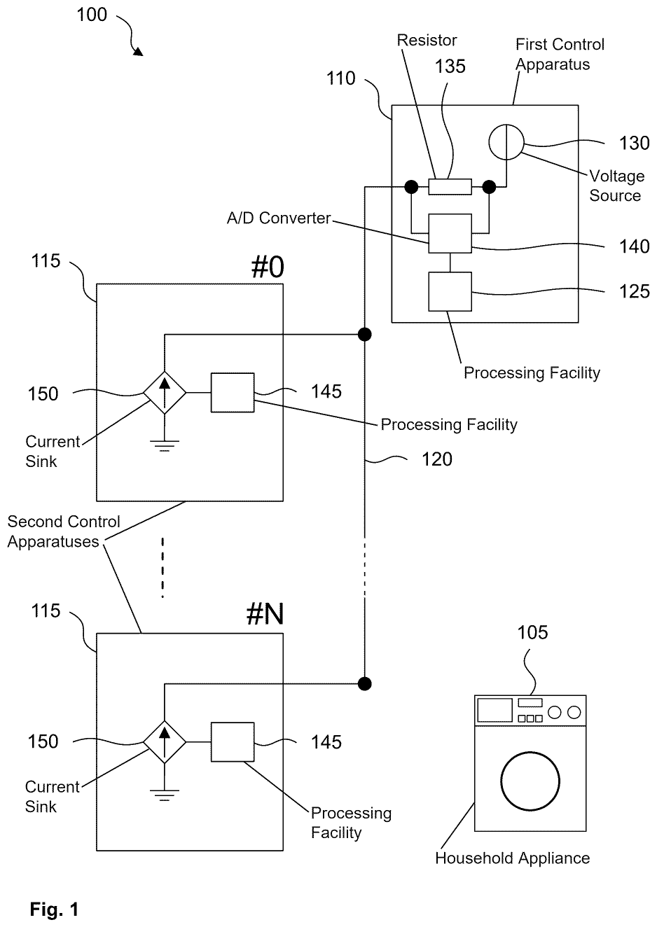

FIG. 1 shows a control system; and

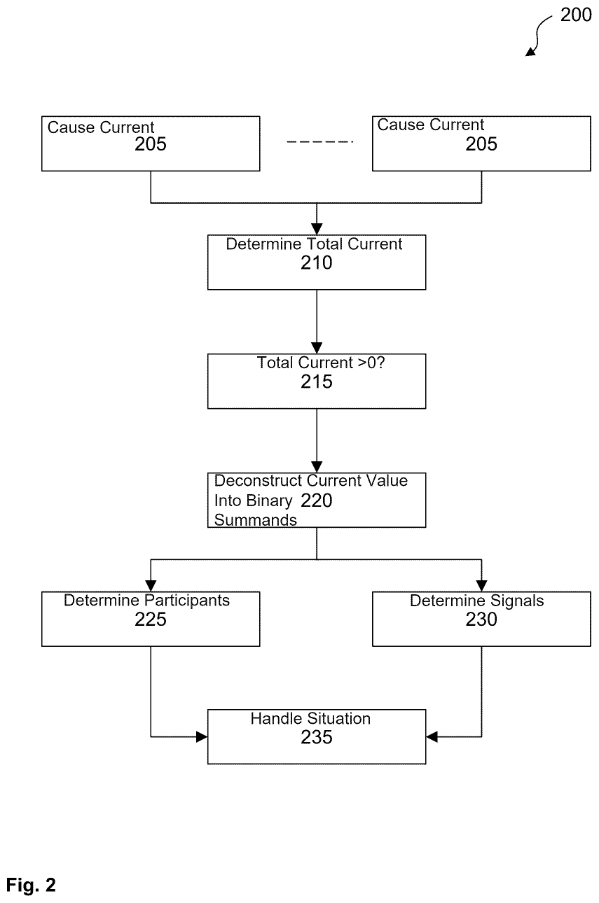

FIG. 2 shows a flowchart of a method.

FIG. 1 illustrates a control system 100 that can be comprised of a household appliance 105. The household appliance 105 is illustrated by way of example as a washing machine; in other embodiments, any other household appliance 105 can also be equipped with a control system 100.

The control system 100 comprises a first control apparatus 110 and a plurality of second control apparatuses 115. The control apparatuses 110, 115 are preferably in each case embodied as microcomputers or microcontrollers or comprise such a facility. The control system 100 is further preferably configured for distributed information processing and in particular for controlling a household appliance 105. The control system 100 is preferably comprised of a single assembly in the household appliance 105. The assembly can comprise a circuit board having a plurality of components. Particularly preferably, the control system having all control apparatuses 110, 115 is realized on an integrated circuit. The circuit can represent one of the components of the assembly.

The control apparatuses 110, 115 are connected to one another by means of a common signal line 120. Further connecting lines, for example for transmitting data, a common supply line or a common ground line between the control apparatuses 110, 115, are not illustrated in FIG. 1.

In the following, a technique is explained for simultaneously transmitting a plurality of signals from one or more of the second control apparatuses 115 to the first control apparatus 110 via the only one signal line 120. In this case, the first control apparatus 110 can decode the individual signals and preferably allocate them in each case to a source.

The first control apparatus 110 comprises a processing facility 125. A voltage source 130 is configured so as to apply a predetermined voltage to the signal line 120. A resistor 135 having a predetermined conductance is provided for determining a total current that is flowing through the signal line 120. A voltage that drops across the resistor 135 can be determined by means of an analog-to-digital converter 140 and forwarded in digital form to the processing facility 125. However, the current that is flowing through the signal line 120 can also be determined in another way, for example inductively or on the basis of a magnetic field around the signal line 120.

In some embodiments, the processing facility 125 is configured so as to control the amount of voltage provided by the voltage source 130. For this purpose, it is possible to include a digital-to-analog converter (DAC).

A second control apparatus 115 comprises a processing facility 145 and a current sink 150. The current sink 150 is configured so as to cause a predetermined electric current from the signal line 120. The processing facility 145 is configured so as to activate or deactivate the current sink 150. In some embodiments, the processing facility 145 can control the amount of a current that is caused by means of the current sink 150.

In the illustrated embodiment, an integer marked with a double cross is allocated to each second control apparatus 115. The numbers start with zero and follow one after the other. Via these numbers, different second control apparatuses 115 can be identified in each case.

Each second control apparatus 115 is allocated a factor or multiple, which results here as a power of two with the allocated number as an exponent. The second control apparatus 115 illustrated above has accordingly allocated the factor 2⁰=1, a subsequent second control apparatus 115 has allocated the factor 2¹=2, a further subsequent 2²=4, etc., to 2^{N} for the second control apparatus 115 illustrated below.

Each second control apparatus 115 can cause an individual signal via the signal line 120 by driving its respective current sink 150 to draw a current from the signal line 120 that corresponds to a product of the predetermined factor and a predetermined base current. A total current, which is composed of individual, respectively characteristic individual currents, then flows through the signal line 120. Each individual current is twice as large as the next smaller individual current.

The total current flowing through the signal line 120 can be determined by the first control apparatus 110 by determining the voltage that drops across the resistor 135. The determined value that indicates the total current can then be broken down into binary summands, wherein a binary summand in each case corresponds to an individual current that can be caused by one of the second control apparatuses 115. This operation essentially corresponds to a conversion of the determined current into a binary value, wherein the value of the least significant bit corresponds to the base current. The processing facility 125 can then identify which of the second control apparatuses 115 has transmitted a signal.

For example, if it is determined that a simple base current flows, the multiple is one, and it can be determined that the second control apparatus 115 having the number zero has transmitted a signal. In the case of a double base current, the multiple is two, so that the second control apparatus 115 having the number one can be determined as the cause. If both second control apparatuses 115 of this example transmit a signal simultaneously, a single and a double base current add up to a total current that corresponds to three times the base current. The first control apparatus 110 can then identify both second control apparatuses 115 as simultaneous transmitters.

By representation as a binary number, one of the second control apparatuses 115 can be directly allocated to each bit of the binary representation. The least significant bit can be allocated to the second control apparatus 115 having the number zero, the next most significant bit can be allocated to the second control apparatus 115 having the number one, and so on. In this manner, the signals of the second control apparatus 115 superimposed on the signal line 120 and represented in each case by individual currents can be reconstructed directly as individual signals within the first control apparatus 110.

In order to prevent a measurement inaccuracy in the determination of the total current flowing through the control line 120 from leading to an incorrect result, the analog-to-digital converter 140 can resolve the flowing current more accurately than is necessary for determining the signals. In other words, it is preferable for a smallest resolvable difference of the analog-to-digital converter 140 to be smaller than the amount of the base current.

If, for example, four second control apparatuses 115 are provided, the ADC 140 can have a resolution of six instead of four bits. The two least significant bits can be ignored. Optionally, by means of a further current sink, preferably in the region of the first control apparatus 110, an offset current can be caused through the signal line 120 that is half as large as is represented by the least significant evaluated bit of the ADC 140. In this way, it can be prevented that one or more bits of the determined representation of the total current are unreliable due to interfering influences such as noise.

It should be noted that in another embodiment, different signals that can be transmitted via the signal line 120 are not allocated to the individual second control apparatuses 115, but rather to predetermined events or states in each case. In such an embodiment, an event or state can be determined by each of the second control apparatuses 115 and signaled on the signal line 120. In order to ensure that the same signal is not given several times, so that a deconstruction of the total current is no longer 7 unambiguous, different second control apparatuses 115 can be allocated different signals that they can each give. The quantities of the respectively available signals can be disjoint.

FIG. 2 illustrates a flowchart of a method 200 that can be performed in particular by means of a control system 100. In a plurality of mutually independent steps 205, individual currents can be caused through the signal line 120 by different second control apparatuses 115.

If a signal is to be transmitted from an individual second control apparatus 115 to the first control apparatus 110, it can cause a predetermined current allocated to it through the control line 120, and otherwise leave a current flowing through the control line 120 uninfluenced. Individual currents of the second control apparatuses 115 add up to a total current. In a step 210, the total current can be determined by the first control apparatus 110. For this purpose, a voltage can be determined that drops across a resistor through which the current flows. A voltage that is present on the signal line 120 can be kept constant at a predetermined value.

In a step 215, it can now be determined whether the total current is greater than zero. If this is not the case, a signal is not present on the control line 120. Otherwise, in a step 220, the determined current can be broken down into binary summands. This can be performed simply by expressing the determined current as a binary number, wherein the least significant bit corresponds to the base current. A predetermined signal can be allocated to each bit. If a value of the bit is one, the signal in question is present, otherwise it is not present.

In a first embodiment, each signal is allocated a different second control apparatus 115. In a step 225, it can be determined on the basis of the set bits which of the second control apparatuses 115 send a signal to the first control apparatus 110.

In an alternative second embodiment, the signals are allocated to individual events or states. In this case, it can be determined in a step 230 on the basis of the active bits which events or states are signaled simultaneously.

In both cases, a reaction to the respective signal, the event or the state can take place in a step 235. For this purpose, further communication between the control apparatuses 110, 115 can take place, which usually takes place by a different route than via the signal line 120.

### REFERENCE CHARACTERS

100 Control system
105 Household appliance
110 First control apparatus
115 Second control apparatus
120 Signal line
125 Processing facility
130 Voltage source
135 Resistor
140 Analog-to-digital converter
145 Processing facility
150 Current sink
200 Method
205 Cause current
210 Determine total current
215 Total current >0?
220 Deconstruct current value into binary summands
225 Determine participants
230 Determine signals
235 Handle situation

1-13. (canceled)

14. A control system, comprising:
a first control apparatus;
a plurality of second control apparatuses;
a signal line connecting said first and second control apparatuses to one another;
said first control apparatus configured to determine a total current flowing through said signal line;
one of said second control apparatuses configured to cause a current to flow out of said signal line, in order to transmit a signal, the current being a predetermined multiple of a predetermined base current; and
different multiples of the predetermined base current being allocated to different signals.

15. The control system according to claim 14, wherein said second control apparatuses are each allocated different multiples of the predetermined base current, and a signal indicates one of said second control apparatuses.

16. The control system according to claim 14, wherein predetermined events are allocated different multiples of the predetermined base current; and a signal indicates one of the events.

17. The control system according to claim 14, wherein different multiples of the predetermined base current are different integer powers of two.

18. The control system according to claim 17, wherein said first control apparatus includes an analog-to-digital converter in order to provide a binary representation of the determined total current, resulting in a bit of the binary representation corresponding to a predetermined signal.

19. The control system according to claim 18, wherein said analog-to-digital converter has a resolution in bits being greater than a number of different multiples of the predetermined base current, and at least one least significant bit is not evaluated.

20. The control system according to claim 14, wherein said first control apparatus includes a voltage source connected to said signal line.

21. The control system according to claim 14, wherein one of said second control apparatuses is configured to cause a predetermined minimum current through said signal line, and said first control apparatus is configured to determine a fault in said signal line when the total current is below the minimum current.

22. The control system according to claim 21, wherein one of said second control apparatuses is furthest away from said first control apparatus relative to said control line, and said one second control apparatus causes the minimum current.

23. A first control apparatus, comprising:
a terminal for a signal line;
a current sensor for determining a current flowing through the signal line; and
a processing facility configured to deconstruct the determined current into predetermined summands each representing a signal;
a summand being a predetermined multiple of a predetermined base current, and different multiples of the predetermined base current being allocated to different signals.

24. A second control apparatus, comprising:
a terminal for a signal line;
a current sink for causing an electric current through said terminal;
the electric current being a predetermined multiple of a predetermined base current; and
a processing facility for controlling said current sink in dependence upon a signal to be provided on the signal line;
different multiples of the predetermined base current being allocated to different signals.

25. A household appliance, comprising the control system according to claim 14.

26. A household appliance, comprising the first control apparatus according to claim 23.

27. A household appliance, comprising the second control apparatus according to claim 24.

28. A method for transmitting signals over a signal line connecting a first control apparatus and a plurality of second control apparatuses to one another, the method comprises the following steps:
using one of the second control apparatuses to cause currents from the signal line;
providing each current as a predetermined multiple of a base current, and allocating different multiples of the predetermined base current to different signals to be transmitted;
using the first control apparatus to determine a total current flowing through the signal line; and
determining signals provided by the second control apparatuses.
